(19) United States
(12) Patent Application Publication
(10) Pub. No.: US 2026/0158929 A1
(43) Pub. Date: Jun. 11, 2026

(54) RAIL CONNECTOR ASSEMBLY FOR DYNAMIC ENERGY TRANSFER SYSTEM

(71) Applicant: Caterpillar Inc., Peoria, IL (US)

(72) Inventors: Ian A. TIGGEMANN, Peoria, IL (US); Antony Stephen PAUL VINCENT, Chennai (IN); Niranjan A. JANAKIRAMAN, Coimbatore (IN)

(73) Assignee: Caterpillar Inc., Peoria, IL (US)

(21) Appl. No.: 18/970,056

(22) Filed: Dec. 5, 2024

(51) Int. Cl. B60L 5/28

(52) U.S. Cl. CPC B60L 5/28

(57) ABSTRACT

A rail connector assembly for connecting a mobile machine to an electrically-conducting rail system includes a boom assembly, a trailing arm assembly, and contactor assembly. The boom assembly includes a main boom and a trailing arm adapter. A first end of the main boom is configured to be coupled to the mobile machine, and a second end of the main boom opposite to the first end is coupled to the trailing arm adapter. The trailing arm adapter includes an angled portion that extends at a non-zero angle from a longitudinal axis of the main boom. The trailing arm assembly is pivotably coupled to an end of the boom adapter. The trailing arm assembly includes a first arm and a second arm. The first arm is coupled to the trailing arm adapter, and includes at least one straight portion and at least one angled portion. The second arm is rotatable relative to the first arm. The contactor assembly is coupled to an end of the trailing arm assembly.

### TECHNICAL FIELD

The present disclosure relates generally to a rail connector assembly for a mobile machine, and more specifically, to a rail connector assembly for connecting an electrically-powered machine to an electrically-conducting rail system.

### BACKGROUND

Mobile industrial machines, such as earth-moving machines, can be of substantial weight and can bear immense loads, thus requiring a significant amount of power. Many industrial machines are driven by internal combustion engines. However, internal combustion engines have drawbacks in the form of fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present unique challenges. For example, the use of hybrid or all-electric systems in an industrial capacity requires a significant investment in infrastructure, particularly due to the location of industrial worksites. Although the use of overhead electricity-conducting rails has been one solution for powering vehicles with predetermined routes or terrain (e.g., trains, subways, buses, etc.), freely-steerable industrial machines and worksites with uneven terrain present hurdles. As a result, existing powered systems, such as overhead trolleys, are not typically used in remote and uneven environments.

Other problems include the ability to safely generate and conduct electricity while ensuring safety. As industrial machine routes may frequently change due to project needs, it is important for the machine systems to securely conduct power to the mobile machine. It is also beneficial for the industrial machine to have control systems with the ability to quickly deploy or retract the connector assembly.

An electric delivery system for providing electric power to a traveling vehicle is disclosed in International Patent App. Pub. No. WO 2020/186296 A1, published on Sep. 24, 2020 (“the '296 publication”). The '296 publication describes an electric delivery system at a mine site for a moving vehicle where two conductors are attached to roadside supports. In order to charge the moving vehicle, the delivery system requires that a retractable arm precisely engage with electrical connectors embedded within a horizontal channel of the roadside barriers.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, a rail connector assembly for connecting a mobile machine to an electrically-conducting rail system includes a boom assembly, a trailing arm assembly, and contactor assembly. The boom assembly includes a main boom and a trailing arm adapter. A first end of the main boom is configured to be coupled to the mobile machine, and a second end of the main boom opposite to the first end is coupled to the trailing arm adapter. The trailing arm adapter includes an angled portion that extends at a non-zero angle from a longitudinal axis of the main boom. The trailing arm assembly is pivotably coupled to an end of the boom adapter. The trailing arm assembly includes a first arm and a second arm. The first arm is coupled to the trailing arm adapter, and includes at least one straight portion and at least one angled portion. The second arm is rotatable relative to the first arm. The contactor assembly is coupled to an end of the trailing arm assembly.

In another aspect, an electrically-powered mobile machine may include a machine frame, a motor, a connector assembly. The motor may be configured to operate a function of the mobile machine. The connector assembly may be coupled to a portion of the machine frame via a boom adapter. The connector assembly may be is configured to connect to an electrically-conductive rail for supplying electrical energy to the motor. The connector assembly may include a boom assembly, a trailing arm assembly, and a contactor assembly. The boom assembly may include a main boom and a trailing arm adapter. A first end of the main boom may be configured to be coupled to the mobile machine via the boom adapter, and a second end of the main boom opposite to the first end may be coupled to the trailing arm adapter. The trailing arm adapter may include an angled portion that extends at a non-zero angle from a longitudinal axis of the main boom. The trailing arm assembly may be pivotably coupled to an end of the trailing arm adapter. The trailing arm assembly may include a first arm and a second arm. The first arm may be coupled to the trailing arm adapter and may include at least one straight portion and at least one angled portion. The second arm may be rotatable relative to the first arm. The contactor assembly may be coupled to an end of the trailing arm assembly.

In yet another aspect, a rail connector assembly for connecting a mobile machine to an electrically-conducting rail system may include a boom assembly, a trailing arm assembly, and a contactor assembly. The boom assembly may include a main boom and a trailing arm adapter. A first end of the main boom may be configured to be coupled to the mobile machine, and a second end of the main boom opposite to the first end may be coupled to the trailing arm adapter. The trailing arm adapter may include an angled portion that extends at a non-zero angle from a longitudinal axis of the main boom. The trailing arm assembly may be pivotably coupled to an end of the trailing arm adapter. The trailing arm assembly may include a first arm and a second arm. The first arm may be coupled to the trailing arm adapter. The first arm may include a first straight portion, a first angled portion, a second straight portion, and a second angled portion. The second arm may be rotatable relative to the first arm. The contactor assembly may be pivotably coupled to an end of the trailing arm assembly.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electric mobile machine connected to a conducting rail power source using a rail connector assembly with a pivoting boom, trailing arm, and connector, according to aspects of the present disclosure.

FIG. 2 is a perspective view of the rail connector assembly in an at least partially deployed or extended configuration.

FIGS. 3A and 3B are perspective views of portions of the rail connector assembly in an at least partially deployed or extended configuration.

FIGS. 4A and 4B are perspective views of portions of the rail connector assembly in a stowed or retracted configuration.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. Additionally, the terms “proximal” and “distal” are used herein to refer to the relative positions of the components of an exemplary machine and/or a rail connector assembly (e.g., boom assembly and other components) coupled to an exemplary machine. When used herein, “proximal” refers to a position relative to closer to the center or middle of the machine. In contrast, “distal” refers to a position relatively further away or extended from the center or middle of the machine. The term “or” is used disjunctively, such that “at least one of A or B” includes, (A), (B), (A and A), (A and B), (B and B), etc.

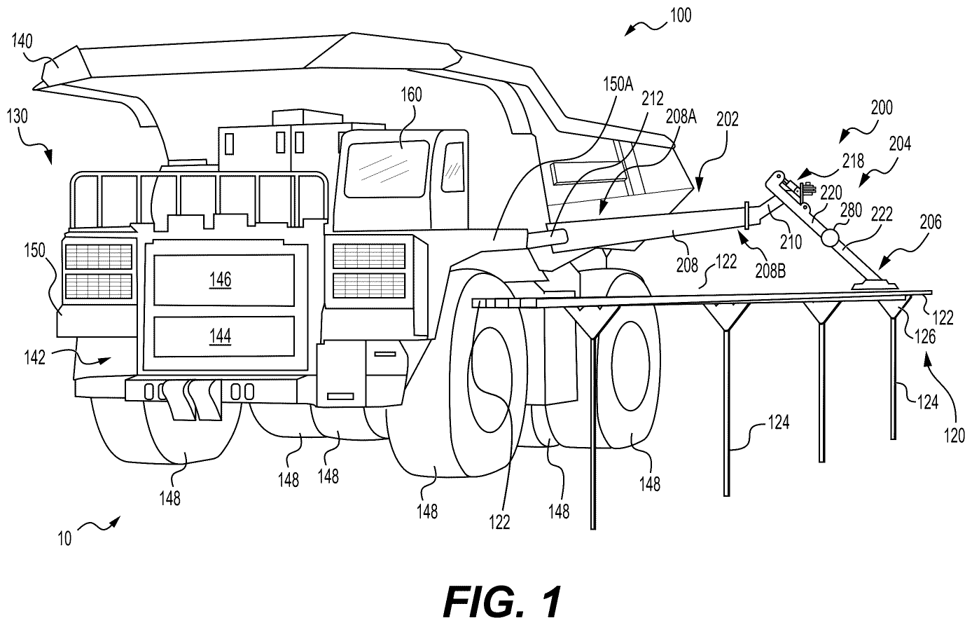

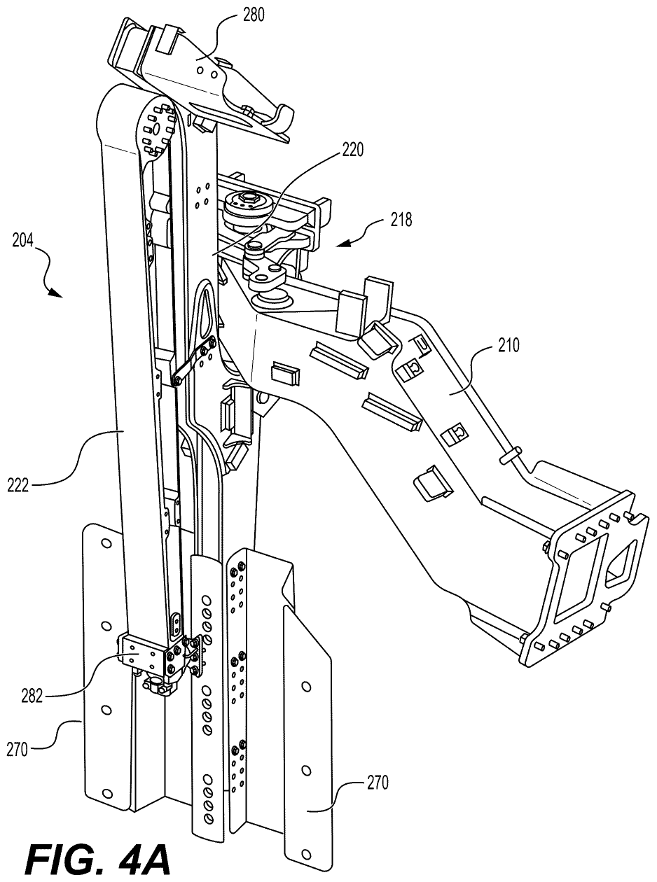

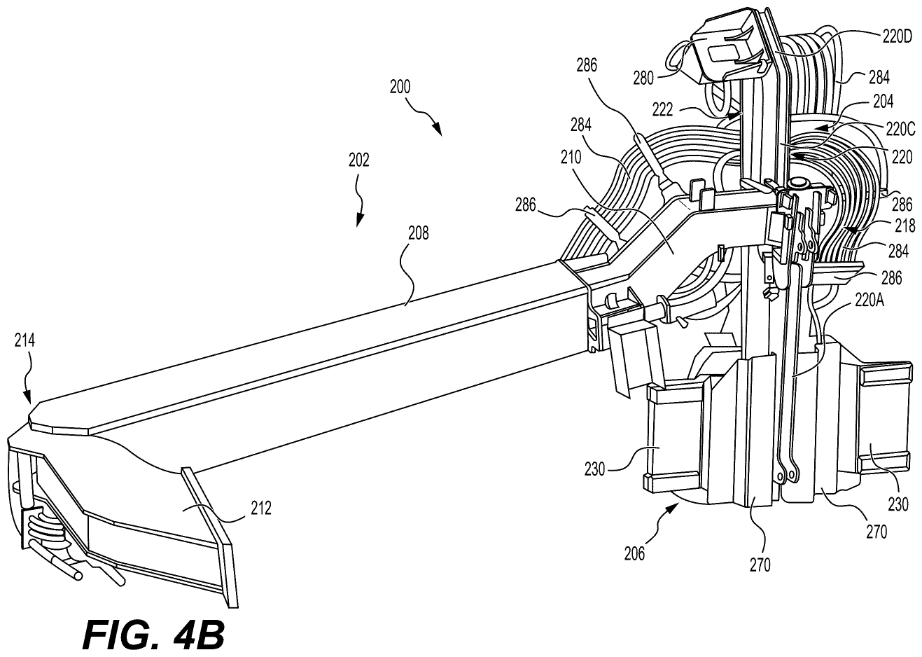

FIG. 1 depicts a mobile machine power system 100, according to aspects of the present disclosure. Mobile machine power system 100 includes an electrically-conducting rail system 120 and a mobile machine 130. Additionally, as discussed in detail below, mobile machine 130 may include a transport portion or bed 140, for example, to be loaded with and convey one or more materials. Furthermore, mobile machine 130 may include or be coupled to a rail connector assembly 200, for example, to electrically connect mobile machine 130 to one or more portions of electrically-conducting rail system 120, for example, to help power, charge, or otherwise supply electrical energy from electrically-conducting rail system 120 to mobile machine 130. Rail connector assembly 200 may include a boom assembly 202, a trailing arm assembly 204, and a contactor assembly 206. As discussed in detail below, various aspects of rail connector assembly 200 may fold or otherwise be positioned relative to each other (e.g., using one or more linear or rotational actuators) to transition between an extended configuration (FIGS. 1, 2, 3A, and 3B) and a retracted configuration (FIGS. 4A and 4B).

Electrically-conducting rail system 120 includes a plurality of conductor rails 122 connected to a power source (not shown), a plurality of support poles 124 secured to a ground surface 10, and a bracket assembly 126. Bracket assembly 126 may be attached to a top end of the each of the support poles 124 to retain the plurality of conducting rails 122 in a secured position (e.g., elevated above the ground). Although not shown, the power source may be, for example, a power grid, one or more generators, and/or one or more energy storage devices. Although FIG. 1 shows an example where the plurality of conductor rails 122 contains three conductor rails, the plurality of conductor rails 122 may contain fewer rails or more rails. In this example, two of the conductor rails provide electrical power at different polarities while the third conductor rail provides a reference of 0 volts. The electrically conducting rail system may alternatively incorporate a three-phase power system, utilizing a three-rail power circuit in addition to a fourth conductor rail providing a reference of 0 volts.

The plurality of support poles 124 may ground the electrically-conducting rail system 120, specifically contacting the conductor rail to provide the reference of 0 volts. Individual support poles 124 may be rods, poles, posts, cylinders, stanchions, or similar structures and have a length for elevating and supporting the plurality of conductor rails 122. The plurality of support poles 124 have a length sufficient to support and stabilize the plurality of conducting rails 122 at a height above the ground 10, for example, at a height of at least eight feet above the ground 10. The plurality of support poles 124 may be formed of dielectric materials such as pultruded fiberglass-reinforced polymer (FRP), or other electrically insulating or dielectric materials. Additionally, rail system 120 may be positioned adjacent to a portion of the ground 10 along a portion of a work route or path to be traversed by mobile machine 130. In some aspects, rail system 120 may be positioned adjacent to an uphill portion of the work route or path, for example, adjacent to an uphill portion of the work route or path that mobile machine 130 will traverse while loaded (e.g., carrying one or more materials). Furthermore, in some aspects, rail system 120 may be positioned such that conductor rails 122 are spaced away from the work route or path that mobile machine 130 will traverse, for example, by approximately 10 feet to approximately 16 feet (e.g., approximately 3 meters to approximately 5 meters).

When in operation, mobile machine 130 and its various systems may be controlled via a machine operator located in an operator cabin 160. Operator cabin 160 may be in a front or forward portion of mobile machine 130. In some aspects, mobile machine 130 may be semi-or fully-autonomous or remotely operated. If fully-autonomous or remotely operated, mobile machine 130 may omit operator cabin 160. In any of these aspects, mobile machine 130 is free-steering and includes an electric drive system 142. Electric drive system 142 may include at least one electric motor 144, and, in some aspects, may include at least one battery system 146. Electric motor 144 may be configured to operate one or more functions of mobile machine 130, for example, to provide motive power to propel mobile machine 130. Battery system 146 may be configured to store electrical energy and/or provide electrical energy to electric motor 144. Electric drive system 142 may be operably coupled to and drive a set of ground-engaging elements 148, such as tires or continuous tracks, for propelling and maneuvering the mobile machine.

Mobile machine 130 also includes a machine frame 150, which supports the mobile machine's mechanical components. Machine frame 150 may be the structural support components of mobile machine 130. Alternatively, machine frame 150 may include the external structure(s) of a body of mobile machine 130. As mentioned above and as discussed in detail below, mobile machine 130 may include or be coupled to rail connector assembly 200. Rail connector assembly 200 may movably coupled to frame 150, for example, to one or more beams, rods, plates, or other portions of machine frame 150. In some aspects, rail connector assembly 200 may be coupled to one or more beams of a rollover protection structure (ROPS) of mobile machine 130. For example, rail connector assembly 200 may be movably coupled to a portion of machine frame 150 below or adjacent to operator cabin 160 and/or in a longitudinal middle portion of mobile machine 130 (e.g., between forward ground engaging elements 148 and rear ground engaging elements 148). Moreover, a portion of rail connector assembly 200 may extend away from machine frame 150 and connect to electrically-conducting rail system 120. In these aspects, rail connector assembly 200 may help to transfer electrical energy from electrically-conducting rail system 120 to mobile machine 130. Mobile machine 130 may utilize either hybrid or all-electric power systems, and the electrically-conducting rail system 120 may be applied to either system. For example, in some aspects, mobile machine 130 may include one or more batteries (e.g., battery system(s) 146). Alternatively or additionally, mobile machine 130 may include one or more engines, which may be used to help drive motor 144. In other aspects, mobile machine 130 may be powered by conductor rails 122, with or without one or more battery system(s) 146. Similarly, in some aspects, mobile machine 130 may be powered by conductor rails 122, with or without one or more engines.

As shown in FIG. 1, exemplary mobile machine 130 travels along the work route or path, with electrically-conducting rail system 120 positioned along a route or path parallel or adjacent to at least a portion of the defined work route. It is noted that mobile machine 130 is shown in the context of a mining truck. In these aspects, the work route or path may lead from a mining source to another destination within the worksite. The present disclosure is not thereby limited, however. Other types of machines are within the scope of the present disclosure. For example, mobile machine 130 may instead be an articulated truck, an asphalt paver, a backhoe loader, a cold planer, a road reclaimer, a compactor, a dozer, a dragline, a drill, a rope shovel, an excavator, a forest machine, a hydraulic mining shovel, a material handler, a motor grader, an off-highway truck, a pipelayer, a skid steer and compact track loader, a telehandler, a track loader, an underground mining dump loader or truck, a wheel loader, a wheel tractor-scraper, or other machine.

As shown in FIG. 1, rail connector assembly 200 may be controlled by an operator to electrically connect mobile machine 130 to electrically-conducting rail system 120. For example, as mentioned above, rail connector assembly 200 includes boom assembly 202, an extension or arm (i.e., trailing arm assembly 204) that can extend and/or trail from boom assembly 202, and a hat or contactor assembly 206. It is noted that FIG. 1 illustrates boom assembly 202, trailing arm assembly 204, and contactor assembly 206 schematically, and the other Figures illustrate additional details of the various assemblies. One or more of boom assembly 202, trailing arm assembly 204, and/or contactor assembly 206 may be pivotable or movable (e.g., extendable and retractable) to electrically connect to one or more portions of rail system 120. As discussed below, rail connector assembly 200 may be movable between at least a retracted or stowed configuration (e.g., FIGS. 4A and 4B) and a pivoted or extended configuration (FIGS. 1, 2, 3A, and 3B).

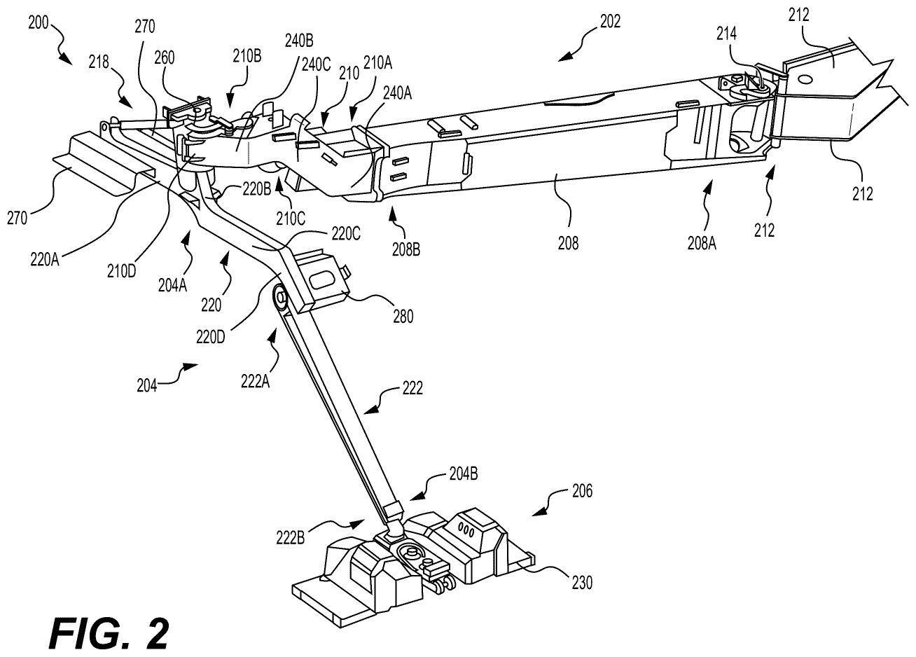

As shown in FIGS. 1 and 2, boom assembly 202 may be a two-part boom assembly, including a main boom 208 and a boom tip, connector, or adapter 210 (trailing arm adapter 210). A first or proximal end 208A of main boom 208 may be coupled to a portion of machine frame 150, for example, via a boom adapter 212. Boom assembly 202 may be pivotable or rotatable relative to machine frame 150 via one or more movable connections (e.g., linear, pivotable, rotatable, etc.) and one or more boom actuators 214 (e.g., a linear hydraulic actuator) between proximal end 208A of main boom 208 and boom adapter 212 on machine frame 150. Although not shown, boom assembly 202 may be secured to another portion of machine frame 150 via one or more boom lock assemblies. Boom adapter 212 is shown as being mounted to machine frame 150, such that main boom 208 pivots about a vertical axis. However, this disclosure is not so limited, and boom adapter 212 may be mounted to or otherwise coupled to machine frame 150 in other configurations and/or main boom 208 may otherwise be pivotable relative to boom adapter 212 and/or machine frame 150.

As shown in FIG. 1, boom assembly 202 may be attached to a side surface 150A (e.g., a lateral side and/or parallel to a direction of travel of mobile machine 130) of frame 150 to pivot or rotate about a joint or pivotable connection(s) formed by boom actuator 214 (FIG. 2). Although boom assembly 202 is shown to be attached to a mining haul truck, boom assembly 202 is capable of being incorporated in various types of mobile machines 130, as boom adapter 212 may be an interchangeable adapter that is specific to the type of machine being operated. Furthermore, although boom assembly 202 is shown as being attached to a left side surface 150A of mobile machine 130 (e.g., relative to a direction of travel), in other aspects, boom assembly 220 may be attached to a right side surface of mobile machine 130.

Additionally, a second or distal end portion 208B of main boom 208 (i.e., opposite to first or proximal end 208A) may be coupled to trailing arm adapter 210. For example, trailing arm adapter 210 may be connected (e.g., fixedly connected) to distal end portion 208B of main boom 208. In these aspects, a first or proximal end portion 210A of trailing arm adapter 210 may be coupled to distal end portion 208B of main boom 208, for example, via one or more bolts, brackets, welds, etc.

Trailing arm adapter 210 includes a second or distal end portion 210B, for example, opposite to proximal end portion 210A. As shown, in some aspects, trailing arm adapter 210 includes an angled portion 210C extending between proximal end portion 210A and distal end portion 210B. For example, angled portion 210C may extend upward (e.g., away from ground surface 10) at a non-zero angle (e.g., between 1 degree to 179 degrees, between 5 degrees and 160 degrees, between approximately 15 degrees to approximately 75 degrees, between approximately 30 degrees and approximately 60 degrees, for example, approximately 45 degrees) from a longitudinal axis of main boom 208. In these aspects, trailing arm adapter 210 may include a first horizontal or straight portion 240A, for example, adjacent to proximal end portion 210A. Trailing arm adapter 210 may also include a second horizontal or straight portion 240B, for example, adjacent to distal end portion 210B. In these aspects, trailing arm adapter 210 includes an angled or vertically sloped portion 240C, extending between first straight portion 240A and second straight portion 240B, for example, upward relative to the longitudinal axis of main boom 208 or first straight portion 240A. Moreover, trailing arm adapter 210 may include an end portion 210D, for example, at a distal end of distal end portion 210B. End portion 210D may extend parallel to the longitudinal axis of main boom 208 and proximal end portion 210A. In some aspects, the shape of trailing arm adapter 210 (e.g., angled portion 210C and vertically sloped portion 240C) may help to add height or elevation for boom assembly 202 (e.g., away from the ground surface 10), which may also help to allow for trailing arm assembly 204 to rotate within a larger range of motion. In these aspects, trailing arm adapter 210 may help to allow for boom assembly 202 and trailing arm assembly 204 to be coupled to different sizes or types of mobile machines 130.

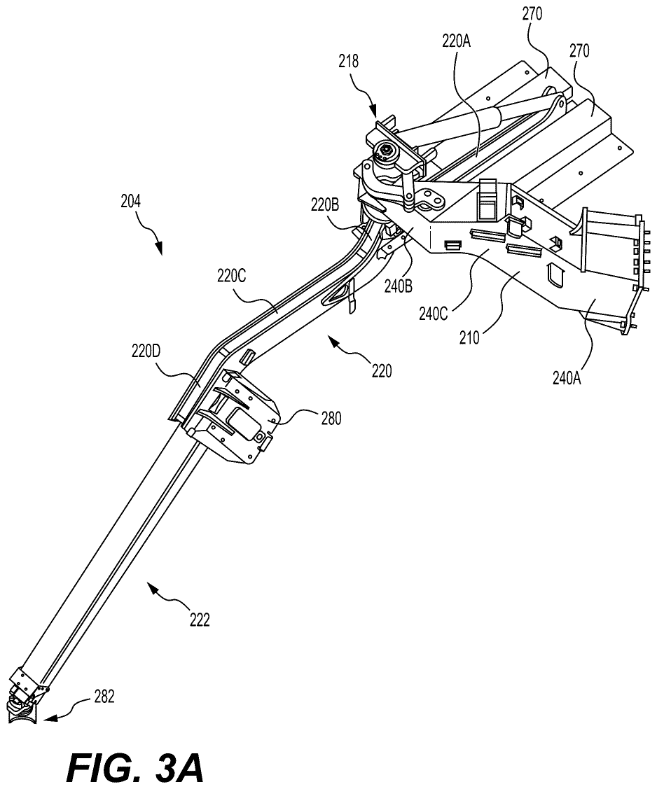

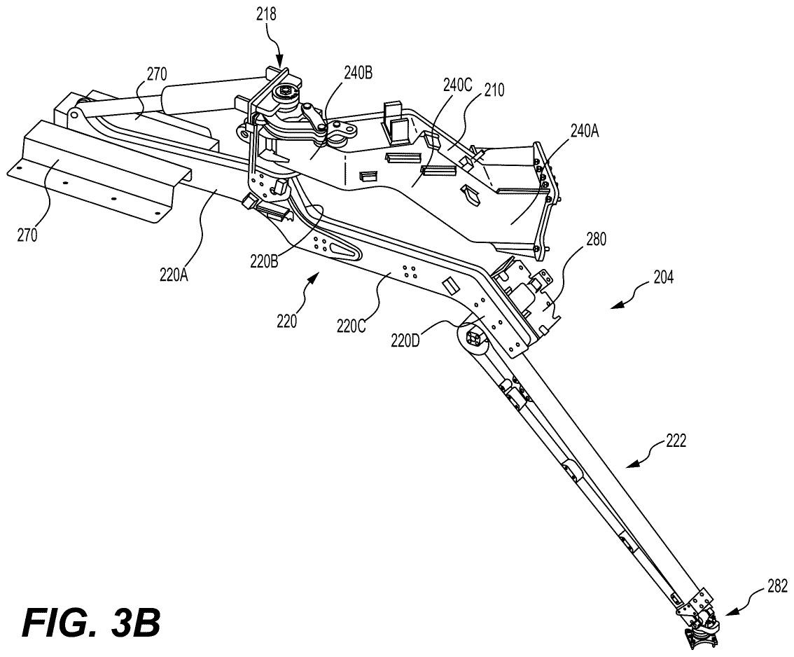

As mentioned, rail connector assembly 200 also includes trailing arm assembly 204, which may be coupled to boom assembly 202 via trailing arm adapter 210. As shown in FIG. 2, trailing arm assembly 204 may be coupled to a bottom portion of trailing arm adapter 210, such that trailing arm assembly 204 may rotate or pivot below or underneath a portion of boom assembly 202. Trailing arm assembly 204 may be coupled to trailing arm adapter 210, for example, to distal end portion 210B of trailing arm adapter 210. For example, a proximal end 204A of trailing arm assembly 204 may be coupled to distal end portion 210B of trailing arm adapter 210, for example, via a movable (e.g., linear, pivotable, rotatable, etc.) connection via a boom/arm actuator 218 (FIGS. 2, 3A, and 3B). Boom/arm actuator 218 may be configured to transition trailing arm assembly 204 between two or more configurations relative to trailing arm adapter 210, for example, between at least a folded or stowed configuration (FIGS. 4A and 4B) and an unfolded or extended configuration (FIGS. 1, 2, 3A and 3B).

In some aspects, trailing arm assembly 204 may be coupled to trailing arm adapter 210 via one or more pivot joints 260. Trailing arm assembly 204 may be movable relative to boom assembly 202 and trailing arm adapter 210 via pivot joint 260. Pivot joint 260 may be or otherwise include one or more actuators (e.g., one or more rotational actuators) and/or one or more locking mechanisms. Additionally, pivot joint 260 may allow for both vertical and horizontal pivoting, for example, as trailing arm 204 is extended or retracted relative to trailing arm adapter 210 and machine frame 150 (FIG. 1). Pivot joint 260 may include one or more brackets, for example, to help support and/or couple pivot joint 260 to one or more portions of boom assembly 202 and/or one or more portions of trailing arm assembly 204. In these aspects, pivot joint 260 may help to control a position or configuration of trailing arm assembly 204 relative to boom assembly 202. Additionally, in some aspects, one or more of trailing arm assembly 204, trailing arm adapter 210, or pivot joint(s) may include one or more pivot lock mechanisms, for example, to secure a position of one or more components of rail connector assembly 200 relative to one or more other components of rail connector assembly 200 or frame 150 of mobile machine 130.

Trailing arm assembly 204 may include a plurality of arms, for example, rotatably or pivotably connected. For example, trailing arm assembly 204 may include at least an upper or first arm 220 and a lower or second arm 222. First arm 220 may be pivotably or rotatably coupled to distal end portion 210B of trailing arm adapter 210, and a proximal portion or end of second arm 222 may be pivotably or rotatably coupled to a distal portion or end of first arm 220.

First arm 220 may include a plurality of portions, for example, extending at angles relative to adjacent portions. A proximal most or first portion 220A of first arm 220 may be generally linear or straight (e.g., a first straight portion). A portion of first portion 220A may include or be coupled to one or more cover plates 270 (e.g., two cover plates 270). When trailing arm assembly 204 is folded (FIGS. 4A and 4B), cover plates 270 may be positioned adjacent to respective portions of contactor assembly 206, for example, to help protect contactor assembly 206. Furthermore, another portion of first portion 220A may be pivotably coupled to trailing arm adapter 210, for example, to end portion 210D. For example, first portion 220A may be coupled to trailing arm adapter 210 via boom/arm actuator 218 and pivot joint 260. In some aspects, as shown in FIG. 2, first portion 220A may be coupled to a bottom portion or face of trailing arm adapter 210 (e.g., underneath or below pivot joint 260). In some aspects, the position or coupling of first portion 220A, and thus first arm 220) to trailing arm adapter 210 may help to allow one or more portions of trailing arm assembly 204 to fold on or adjacent to one another (e.g., for second arm 222 to be fold adjacent to first arm 220 in a stowed or retracted configuration).

First arm 220 also includes a second portion 220B, for example, distal to first portion 220A. In some aspects, second portion 220B is angled relative to a longitudinal axis of first portion 220A (e.g., forming a first angled portion). For example, second portion 220B may be positioned distal to first portion 220A, and may extend at a non-zero angle (e.g., between 1 degree to 179 degrees, between 5 degrees and 160 degrees, between approximately 15 degrees to approximately 75 degrees, between approximately 30 degrees and approximately 60 degrees, for example, approximately 45 degrees) relative to first portion 220A. In some aspects, second portion 220B includes a shorter length than first portion 220A.

First arm 220 further includes a third portion 220C, for example, distal to second portion 220B. In some aspects, third portion 220C extends substantially parallel to first portion 220A (e.g., extending at the same angle relative to second portion 220B as second portion 220B extends relative to first portion 220A). Additionally, third portion 220C may include a same or similar length as first portion 220A. In these aspects, third portion 220C may form a second straight portion of first arm 220.

Moreover, first arm 220 includes a fourth portion 220D, for example, distal to third portion 220C. In some aspects, fourth portion 220D is angled relative to a longitudinal axis of third portion 220C (e.g., forming a second angled portion). For example, fourth portion 220D may be positioned distal to third portion 220C, and may extend at a non-zero angle (e.g., between 1 degree to 179 degrees, between 5 degrees and 160 degrees, between approximately 15 degrees to approximately 75 degrees, between approximately 30 degrees and approximately 60 degrees, for example, approximately 45 degrees) relative to third portion 220C. In some aspects, fourth portion 220D includes a shorter length than third portion 220C. Additionally, in some aspects, fourth portion 220D is parallel to or the same length as second portion 220B.

Furthermore, a portion of fourth portion 220D may at least partially overlap with and be coupled to proximal end portion 222A of second arm 222. For example, a portion of fourth portion 220D may include or be coupled to a trailing arm actuator 280. Trailing arm actuator 280 may rotatably or pivotably couple fourth portion 220D to proximal end portion 222A of second arm 222, for example, to transition second arm 222 between at least an extended configuration (FIGS. 1, 2, 3A, and 3B) to a retracted or stowed configuration (FIGS. 4A and 4B). In some aspects, first arm 220 may be formed of a steel (e.g., fabricated steel, such as stainless steel), for example, via machining, molding, etc.

Second arm 222 may be generally straight or planar, for example, with a longitudinal axis extending along a single plane. In some aspects, second arm 222 may include one or more tapers. For example, a proximal end portion 222A of second arm 222 may be thicker or larger than a distal end portion 222B of second arm 222. In some aspects, one or more portions of second arm 222 may be formed of a lightweight material (e.g., aluminum or an aluminum alloy). Second arm 222 may be machined. In these aspects, the weight of second arm may be reduced. Additionally, a distal end 204B of trailing arm assembly 204 (e.g., distal end portion 222B of second arm 222) may be coupled to contactor assembly 206.

Second arm 222 may be coupled to first arm 220 via one or more trailing arm actuators 280. Trailing arm actuator 280 may include a rotatable or pivotable connection (e.g., a hydraulic rotary actuator), for example, such that proximal end portion 222A of second arm 222 is movable relative to distal end portion 220B of first arm 220. In some aspects, proximal end portion 222A of second arm 222 may be below (e.g., toward the ground surface, and away from boom assembly 202) fourth portion 220D of first arm 220, which may help with the extension or retraction of second arm 222 relative to first arm 220.

Trailing arm assembly 204 (e.g., second arm 222) may be coupled to (e.g., pivotably or rotatably coupled to) one or more portions of contactor assembly 206. In some aspects, one or more other portions of trailing arm assembly 204 (e.g., second arm 222) may be directly coupled to one or more portions of contactor assembly 206. Contactor assembly 206 may include a base frame 230 in which a plurality of conducting terminals (not shown) are secured. In an exemplary configuration, nine conducting terminals are arranged in a three-by-three matrix to provide redundancy and maintain electrical connection with conductor rails 122; however, conducting terminals may be arranged in different quantities and in other configurations. In the exemplary rail configuration of three conductor rails 122 and utilizing the three-by-three conducting terminal matrix, the plurality of conducting terminals are split into three equal groups of three conducting terminals arranged in a linear fashion. The three groups of linear conducting terminals each correspond to one of the positive polarity conductor rail, the negative polarity conductor rail, and the conductor rail providing a reference of 0 volts.

Based on the configuration of one or more of boom actuator 214, boom/arm actuator 218, and trailing arm actuator 280, trailing arm assembly 204 may transition between an at least partially deployed or extended configuration (FIGS. 1, 2, 3A, and 3B), a folded or stowed configuration (FIGS. 4A and 4B), and vice versa. Moreover, one or more of boom actuator 214, boom/arm actuator 218, and trailing arm actuator 280 may be hydraulically or pneumatically controlled. Alternatively or additionally, one or more of these boom actuator 214, boom/arm actuator 218, and trailing arm actuator 280 may be controlled by one or more motors. Furthermore, the position or orientation of trailing arm assembly 204 and/or contactor assembly 206 may be controlled by one or more hydraulic systems, pneumatic systems, motors, etc.

FIGS. 3A and 3B illustrate additional views of a portion of rail connector assembly 200 in an at least partially extended configuration. Specifically, FIGS. 3A and 3B illustrate trailing arm adapter 210 and trailing arm assembly 204, without main boom 208 or contactor assembly 206. As mentioned above, trailing arm adapter 210 includes vertically sloped portion 240C between straight or horizontal portions 240A and 240B, and a portion of trailing arm assembly 204 is coupled to straight portion 240B via one or more rotatable or pivotable connections formed by boom/arm actuator 218. Furthermore, trailing arm assembly 204 includes first arm 220 and second arm 222. As mentioned, first arm 220 includes a plurality of portions 220A, 220B, 220C, and 220D, with first portion 220A including or being coupled to one or more cover plates 270. Additionally, fourth portion 220D of first arm 220 is coupled to second arm 222 via one or more trailing arm actuators 280, for example, such that second arm 222 may pivot or rotate relative to first arm 220. Furthermore, an end portion of second arm 222 may include one or more connection assemblies 282, for example, to couple (e.g., physically and/or electrically couple) contactor assembly 206 (FIG. 2) to second arm 222.

FIGS. 4A and 4B illustrate views of various portions of rail connector assembly 200 in a retracted or stowed configuration. FIG. 4A illustrates trailing arm adapter 210 and trailing arm assembly 204 (e.g., without main boom 208 and rail contactor assembly 206), with trailing arm assembly 204 in the retracted or stowed configuration. As shown, first arm 220 is retracted or stowed relative to trailing arm adapter 210, for example, via actuation of boom/arm actuator 218. Additionally, second arm 222 is retracted or stowed relative to first arm 220, for example, via actuation of trailing arm actuator 280. In these aspects, connection assembly 282 and rail contactor assembly 206 (FIG. 2) may be adjacent to one or more cover plates 270, which may help to protect connection assembly 282 and rail contactor assembly 206.

FIG. 4B illustrates trailing arm adapter 210 coupled to main boom 208, and main boom 208 is coupled to boom adapter 212. Boom adapter 212 may be coupled to a portion (e.g., frame 150) of mobile machine 130, as shown in FIG. 1. Additionally, main boom 208 may be pivotable or rotatable relative to boom adapter 212, for example, via boom actuator 214. In these aspects, at least a portion of main boom 208 may be adjacent to or flush with mobile machine 130 when in the retracted or stowed configuration. In some aspects, the retracted or stowed configuration may include portions of rail connector assembly 206 being adjacent to side portions and/or front portions of mobile machine 130. For example, as shown in FIG. 4B, main boom 208 may be positioned at a non-zero angle (e.g., approximately 90 degrees) relative to boom adapter 212 when rail connector assembly 200 in a retracted or stowed configuration. In some aspects, main boom 208 may be positioned in-line with mobile machine 130 (FIG. 1) when in the retracted or stowed configuration. In some aspects, boom adapter 212 may be positioned on a side or corner of mobile machine 130 (FIG. 1), and rail connector assembly 200 may be extendable to a side (e.g., a left hand side or a right hand side) of mobile machine 130.

FIG. 4B also illustrates trailing arm assembly 204 coupled to main boom 208 via trailing arm adapter 210. As discussed above, first arm 220 and second arm 222 of trailing arm assembly 204 may be retracted or stowed adjacent to one another, for example, via trailing arm actuator 280. For example, first arm 220 and second arm 222 may be folded to be adjacent to one another, which may reduce the overall size and/or footprint of trailing arm assembly 204 when in the retracted or stowed configuration. Additionally, cover plates 270 may be adjacent to portions of rail connector assembly 206. Furthermore, as shown in FIG. 4B, one or more wires, tubes, connectors, or cables 284 may extend from rail connector assembly 206 to mobile machine 130 (FIG. 1), for example, through one or more cable holders or protectors 286. Cable protectors 286 may extend along or adjacent to a portion of trailing arm assembly 204. Cable protectors 286 may help to enclose, guide, secure, or otherwise protect one or more cables 284, wires, or other conduits extending between, for example, contactor assembly 206 and machine frame 150 (e.g., along boom assembly 202, via one or more openings or channels in boom assembly 202, etc.). It is noted that cables 284 and cable protectors 286 are omitted in the other figures for clarity.

Although not shown, rail connector assembly 200 may include one or more of hydraulic systems, pneumatic systems, and/or busbar assemblies. For example, rail connector assembly 200 may include one or more hydraulic pumps, control valves, hydraulic fluid cables, etc., for example, to help move or otherwise control the position of one or more of boom assembly 202, trailing arm assembly 204, rail contactor assembly 206, etc. (e.g., between the at least partially extended configuration and the retracted or stowed configuration). Each of these one or more systems or assemblies may be located partially or entirely within a housing of main boom 208, coupled to a surface of main boom 208, adjacent to main boom 208, etc.

Furthermore, although not shown, one or more of machine frame 150 and/or boom assembly 202 may include one or more sensors (e.g., proximity sensors), for example, to help detect, signal, or otherwise indicate a position of boom assembly 202 relative to machine frame 150. In other aspects, one or more of boom assembly 202, trailing arm assembly 204, and/or contactor assembly 206 may include one or more angular position sensors, orientation sensors, inertial measurement sensors (IMUs), etc., for example, to help provide one or more references for the relative locations and/or positions.

### INDUSTRIAL APPLICABILITY

The disclosed aspects discussed above can be used for deploying a rail connector assembly and charging a moving free-steering machine, for example, with energy from an electrically-conducting rail system on an industrial worksite. In order to operate mobile machine 130, mobile machine 130 is controlled by an operator, either remotely or present in operator cabin 160, or autonomously. Upon approaching electrically-conducting rail system 120, rail connector assembly 200 may be deployed (e.g., from the retracted or stowed configuration shown in FIGS. 4A and 4B). This deployment may be the result of the operator initiating the deployment or may occur autonomously via a signal generated due to the geographic location of mobile machine 130 (e.g., a position identified with a global navigation satellite system) and proximity to rails 122.

As discussed above, boom assembly 202 includes main boom 208 and trailing arm adapter 210, and trailing arm adapter 210 may include one or more angled portions 210C extending at a non-zero angle relative to main boom 208, forming vertically sloped portion 240C. As a result, the remaining components of rail connector assembly 200 (e.g., trailing arm assembly 204 and/or contactor assembly 206) may be elevated above a ground surface (e.g., positioned with a greater clearance), and/or positioned closer to one or more portions of machine frame 150 (e.g., operator cabin 160) than if trailing arm adapter 210 did not include any angled portions. In these aspects, trailing arm assembly 204 and/or contactor assembly 206 may be spaced away from dirt, rocks, obstacles, and/or other materials on or kicked up from the ground surface as mobile machine 130 traverses the ground (e.g., both in the at least partially extended configuration and in the retracted or stowed configuration). Trailing arm assembly 204 and/or contactor assembly 206 may also be positioned away from bed 140, for example, helping to protect trailing arm assembly 204 and/or contactor assembly 206 during loading, travel, and/or unloading. Additionally, trailing arm adapter 210 may help to allow for rail connector assembly 200 to be coupled to different machines (e.g., different sizes of machines, different types of machines, etc.), while still helping to allow for an appropriate positioning of trailing arm assembly 204 and, correspondingly, contactor assembly 206 relative to conductor rails 122.

Additionally, the mounting position of main boom 208 relative to machine frame 150 and/or the angle of trailing arm adapter 210 relative to main boom 208 may help to account for machine frame 150 lowering in height during use (e.g., when bed 140 is loaded with material(s)). In these aspects, the components of rail connector assembly 200 may be positioned closer to machine frame 150 and/or farther away from the ground surface, both in the retracted or stowed configuration (e.g., FIGS. 4A and 4B) and a pivoted or extended configuration (FIGS. 1, 2, 3A, and 3B).

Furthermore, trailing arm adapter 210 may help for contactor assembly 206 to be elevated from the ground surface when rail connector assembly 200 is in the pivoted or extended configuration (FIGS. 1, 2, 3A, and 3B). For example, contactor assembly 206 may be positioned to a height above or to the height of conductor rails 122 based on the shape of trailing arm adapter 210. In some aspects, conductor rails 122 may be spaced above the ground surface to allow for people or machinery to pass under conductor rails 122, but contactor assembly 206 may be positioned above or to the height of conductor rails 122. In some aspects, the elevation from trailing arm adapter 210 may help to allow trailing arm assembly 204 to rotate or otherwise move within a range of motion, for example, underneath or below boom assembly 202. In some aspects, trailing arm adapter 210 may be angled, for example, toward the rear of mobile machine 130, and/or may otherwise help to support boom/arm actuator 218.

As mentioned above, boom assembly 202 may be coupled to machine frame 150 in a middle position or side 150A of machine frame 150, for example, to one or more beams (e.g., rollover protection system (ROPS) beams or supports). For example, boom assembly 202 may be coupled to machine frame 150 at a position close to the center of gravity of mobile machine 130. In these aspects, the coupling of boom assembly 202 to machine frame 150 may help to reduce a risk of mobile machine 130 rolling over or otherwise being off-balance, both with rail connector assembly 200 in the retracted or stowed configuration and with rail connector assembly 200 in a pivoted or extended configuration. Additionally, in some aspects, rail connector assembly 200 may be coupled to an existing mobile machine, for example, by retrofitting the existing mobile machine by coupling rail connector assembly 200 to existing portion(s) of the frame of the existing mobile machine frame.

In some aspects, various aspects of rail connector assembly 200 may help to position portions of rail connector assembly 200 relative to machine frame 150. For example, various aspects of rail connector assembly 200 may help to position trailing arm assembly 204 and/or contactor assembly 206 at a position in front of (e.g., adjacent to a front portion of machine frame 150) and/or below operator cabin 160 (FIG. 1). This positioning may help to prevent rail connector assembly 200 from impairing or otherwise interfering with an operator's field of view and/or sightlines. Similarly, the position of various portions of rail connector assembly 200 may not impair or otherwise interfere with the field of view or sightlines of one or more sensors coupled to mobile machine 130 (e.g., stringline sensors, cameras, proximity sensors, etc.) on machine frame 150, and/or observation from a position remote to mobile machine 130 (e.g., when operated remotely).

Moreover, the shape of one or more portions of trailing arm assembly 204 may help to allow for the extension and retraction/stowing of trailing arm assembly 204. For example, the shape of first arm 220 (e.g., including first portion 220A, second portion 220B, third portion 220C, and fourth portion 220D) may allow for trailing arm assembly 204 to be extended such that contactor assembly 206 reaches conductor rails 122. The shape of first arm 220 may also allow for trailing arm assembly to be retracted/stowed close to mobile machine 130 and away from the ground surface 10. For example, the bend or angle in second portion 220B of first arm 220 may allow for first arm 220 to fold or otherwise change orientation relative to trailing arm adapter 210.

Additionally, the coupling of trailing arm assembly 204 (e.g., first arm 220) to a position below end portion 210D and distal end portion 210B of trailing arm adapter 210 may allow for trailing arm assembly 204 to rotate through a range of motion below trailing arm adapter 210. The shape of first arm 220 may also allow for trailing arm assembly 204 to rotate below main boom 208, for example, when in the at least partially deployed or extended configuration. The rotation via rotatable or pivotable connection formed by boom/arm actuator 218 may allow for extension and/or retraction of trailing arm assembly without a linear actuator. Furthermore, trailing arm assembly 204 (e.g., first arm 220 and second arm 222) may fold on itself. For example, second arm 222 may fold (e.g., via trailing arm actuator 280) such that at least a portion of second arm 222 is flat or otherwise adjacent to a surface (e.g., a lower surface) of first arm 220. In these aspects, first portion 220A of first arm 220 may include one or more cover plates 270, which may be positioned adjacent to and help protect one or more portions of rail contactor assembly 206 when in the retracted/stowed configuration. In these aspects, the footprint or amount of space taken up by trailing arm assembly 204 in the retracted/stowed configuration may be reduced.

Furthermore, second arm 222 may be formed of aluminum or an aluminum alloy, while first arm 220 may be formed of a steel (e.g., fabricated steel, such as stainless steel). In these aspects, first arm 220 may help to distribute the load of trailing arm assembly 204. Furthermore, the overall cost and/or weight of second arm 222 may be reduced. Additionally, second arm 222 may include a taper, for example, from proximal end portion 222A to distal end portion 222B, which may also help to reduce the overall cost and/or weight of second arm 222.

In all of these aspects, rail connector assembly 200 may help mobile machine 130 to rapidly deploy and/or engage rail connector assembly 200 onto an electrically-conducting rail system. Rail connector assembly 200 may be used with multiple types of mobile machines 130 to supply electrical energy from electrically-conducting rail system 120, which may be positioned to a side of mobile machine (e.g., adjacent to portion of the work route or path). For example, rail connector assembly 200 may help to convey electrical energy (e.g., via contactor assembly 206, various electrical conduits, busbars or other conduits through boom assembly 202, etc.) and help to power on or more motors 144 and/or charge battery system 146 of mobile machine 130.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A rail connector assembly for connecting a mobile machine to an electrically-conducting rail system, the rail connector assembly comprising:
a boom assembly, including a main boom and a trailing arm adapter, wherein a first end of the main boom is configured to be coupled to the mobile machine, wherein a second end of the main boom opposite to the first end is coupled to the trailing arm adapter, and wherein the trailing arm adapter includes an angled portion that extends at a non-zero angle from a longitudinal axis of the main boom;
a trailing arm assembly, wherein the trailing arm assembly is pivotably coupled to an end of the boom adapter, wherein the trailing arm assembly includes a first arm and a second arm, wherein the first arm is coupled to the trailing arm adapter and includes at least one straight portion and at least one angled portion, and wherein the second arm is rotatable relative to the first arm; and
a contactor assembly, wherein the contactor assembly is coupled to an end of the trailing arm assembly.

2. The rail connector assembly of claim 1, wherein the angled portion of the trailing arm adapter extends at a non-zero angle from the longitudinal axis of the main boom.

3. The rail connector assembly of claim 1, wherein the first arm includes a first straight portion, a first angled portion, a second straight portion, and a second angled portion.

4. The rail connector assembly of claim 3, wherein the first straight portion of the first arm is pivotably coupled to the trailing arm adapter, and wherein the second angled portion of the first arm is rotatably coupled to a portion of the second arm via a trailing arm actuator.

5. The rail connector assembly of claim 4, wherein the portion of the second arm coupled to the second angled portion of the first arm via the trailing arm actuator is positioned below the second angled portion of the first arm.

6. The rail connector assembly of claim 3, wherein the first straight portion of the first arm further includes one or more cover plates configured to cover one or more portions of the contactor assembly when the rail connector assembly is in a retracted or stowed configuration.

7. The rail connector assembly of claim 1, wherein the second arm includes a taper from a proximal portion to a distal portion.

8. The rail connector assembly of claim 7, wherein the first arm is formed of fabricated steel, and wherein the second arm is formed of aluminum.

9. An electrically-powered mobile machine, the electrically-powered mobile machine comprising:
a machine frame;
a motor configured to operate a function of the mobile machine; and
a connector assembly coupled to a portion of the machine frame via a boom adapter, wherein the connector assembly is configured to connect to an electrically-conductive rail for supplying electrical energy to the motor, wherein the connector assembly includes:
a boom assembly, including a main boom and a trailing arm adapter, wherein a first end of the main boom is configured to be coupled to the mobile machine via the boom adapter, wherein a second end of the main boom opposite to the first end is coupled to the trailing arm adapter, and wherein the trailing arm adapter includes an angled portion that extends at a non-zero angle from a longitudinal axis of the main boom;
a trailing arm assembly, wherein the trailing arm assembly is pivotably coupled to an end of the trailing arm adapter, wherein the trailing arm assembly includes a first arm and a second arm, wherein the first arm is coupled to the trailing arm adapter and includes at least one straight portion and at least one angled portion, and wherein the second arm is rotatable relative to the first arm; and
a contactor assembly, wherein the contactor assembly is coupled to an end of the trailing arm assembly.

10. The electrically-powered mobile machine of claim 9, wherein the angled portion of the trailing arm adapter extends at a non-zero angle from the longitudinal axis of the main boom.

11. The electrically-powered mobile machine of claim 9, wherein the first arm includes a first straight portion, a first angled portion, a second straight portion, and a second angled portion, wherein the first straight portion is pivotably coupled to the trailing arm adapter, and wherein the second arm is rotatably coupled to the second angled portion via a trailing arm actuator.

12. The electrically-powered mobile machine of claim 11, wherein the portion of the second arm coupled to the second angled portion of the first arm via the trailing arm actuator is positioned below the second angled portion of the first arm.

13. The electrically-powered mobile machine of claim 12, wherein the first straight portion of the first arm further includes one or more cover plates configured to cover one or more portions of the contactor assembly when the contactor assembly is in a retracted or stowed configuration.

14. The electrically-powered mobile machine of claim 9, wherein the electrically-powered mobile machine includes an operator cabin, and wherein the main boom is coupled to a side of the machine frame at a position below or behind the operator cabin.

15. The electrically-powered mobile machine of claim 9, wherein the first arm is formed of fabricated steel, and wherein the second arm is formed of aluminum.

16. The electrically-powered mobile machine of claim 15, wherein the second arm includes a taper from a proximal portion to a distal portion.

17. The electrically-powered mobile machine of claim 9, further comprising a storage device for storing electrical energy, wherein the connector assembly includes one or more cables electrically connecting the contactor assembly to the storage device.

18. A rail connector assembly for connecting a mobile machine to an electrically-conducting rail system, the rail connector assembly comprising:
a boom assembly, including a main boom and a trailing arm adapter, wherein a first end of the main boom is configured to be coupled to the mobile machine, wherein a second end of the main boom opposite to the first end is coupled to the trailing arm adapter, and wherein the trailing arm adapter includes an angled portion that extends at a non-zero angle from a longitudinal axis of the main boom;
a trailing arm assembly, wherein the trailing arm assembly is pivotably coupled to an end of the trailing arm adapter, wherein the trailing arm assembly includes a first arm and a second arm, wherein the first arm is coupled to the trailing arm adapter, wherein the first arm includes a first straight portion, a first angled portion, a second straight portion, and a second angled portion, and wherein the second arm is rotatable relative to the first arm; and
a contactor assembly, wherein the contactor assembly is pivotably coupled to an end of the trailing arm assembly.

19. The rail connector assembly of claim 18, wherein the first straight portion of the first arm is pivotably coupled to the trailing arm adapter, and wherein the second angled portion of the first arm is rotatably coupled to a portion of the second arm via a trailing arm actuator.

20. The rail connector assembly of claim 18, wherein the first arm is formed of fabricated steel, wherein the second arm is formed of aluminum or an aluminum alloy, and wherein the second arm includes a tapered portion that reduces in size from a proximal portion to a distal portion.
